(19) United States
(12) Patent Application Publication
(10) Pub. No.: US 2023/0151652 A1
(43) Pub. Date: May 18, 2023

(54) SPRING HINGE WITH HANDLE LATCH

(71) Applicant: Robert K. Branscombe, JR., Leominster, MA (US)

(72) Inventor: Robert K. Branscombe, JR., Leominster, MA (US)

(21) Appl. No.: 17/528,332

(22) Filed: Nov. 17, 2021

(51) Int. Cl. E05C 3/14

(52) U.S. Cl. CPC E05C 3/14

(57) ABSTRACT

Disclosed herein is a spring hinge with handle latch comprising of spring hinge with an attached handle and an optional anchor for attaching the device. In some embodiments, the spring hinge with handle latch can be attached to furniture, cabinets, containers, carts, and any apparatus with hinged or loose elements. The handle secures hinged or loose elements in their stored, opened, or extended positions. The spring hinge provides the necessary tension. Also disclosed herein are various examples of use for a spring hinge with handle latch.

### BACKGROUND—PRIOR ART

The following is a tabulation of some prior that presently appears relevant:

U.S. Patents

| Patent Number | Kind Code | Issue Date | Patentee |
|---|---|---|---|
| 2159564 | B1 | May 23, 1939 | McPherson |
| 2879119 | B1 | Mar. 24, 1959 | Bullock |
| 5365861 | B1 | Nov. 22, 1994 | Gutgsell |
| 2660498 | B1 | Nov. 24, 1953 | Norquist |
| 2230220 | B1 | Feb. 4, 1941 | Cummins |
| 2621095 | B1 | Dec. 9, 1952 | Haumerson |
| 1807184 | B1 | May 26, 1931 | Wagner |
| 8051784 | B2 | Nov. 8, 2011 | Hsu |
| 7096535 | B2 | Jun. 13, 2006 | Koshikawa et al. |
| 10800584 | B2 | Oct. 13, 2020 | Giraud et al. |
| 7640870 | B2 | Jan. 5, 2010 | L. Curtis Strong et al |
| 8555791 | B2 | Oct. 15, 2013 | Ju-Young Jin, Cai Yixian |
| 11149481 | B2 | Oct. 19, 2021 | Tanriverdi |
| 11111708 | B2 | Sep. 7, 2021 | Kruedener et al. |
| 4058333 | A1 | Nov. 15, 1977 | Roe et al. |
| 5067625 | A1 | Nov. 26, 1991 | Numata |
| 4969586 | A1 | Nov. 13, 1990 | Ostroski |

Nonpatent Literature Documents
https://www.rockler.com/posi-lock-folding-leg-bracket
https://www.thehardwarehut.com/catalog-product.php?p_ref=348571
https://www.thehardwarehut.com/catalog-product.php?p_ref=366740

### FIELD OF THE DISCLOSURE

The present disclosure relates to spring hinge with handle latch comprising a spring hinge with an attached handle and an optional anchor for attaching the device. The present disclosure also relates to various possible uses of the spring hinge with handle latch herein.

### BACKGROUND

Currently, there is market demand for improving home organization and maximizing living space. As such, portability and storage of furniture and other household items is often desirable.

Locking hinges on furniture, collapsible carts, and other items provide the ability to make their respective units compact for easier storage and/or transporting.

Locking hinges also allow furniture arms and legs, carts, and other items to extend back into place while also locking to prevent collapsing back into their compacted positions.

While useful and very common, many available locking hinges present a safety risk to users having their fingers pinched. Because of this, many locking hinges available on the market today can be unsafe for adults with delicate skin and/or brittle bones or for children. In addition, many locking hinges require a degree of dexterity and strength that many adults and children do not have.

In addition, this invention provides the ability to secure doors and container lids and this use is noted herein.

The manufacturing costs of currently available locking hinges can likely be reduced with a device requiring fewer parts such as this invention.

This invention serves these market needs.

### SUMMARY OF THE DISCLOSURE

Disclosed herein is a spring hinge with handle latch with an optional anchor for attaching the device. The present disclosure also relates to various possible uses of the spring hinge with handle latch herein.

There are two embodiments of the spring hinge with handle latch: one embodiment including the spring hinge, handle latch and optional anchor, and one embodiment without an anchor.

FIGS. 1-4 depicts the spring hinge with handle latch including the optional anchor. FIG. 1 depicts a front-view, FIGS. 2 and 3 depict perspective-views, and FIG. 4 depicts a side-view.

The spring hinge is a self-closing hinge that could be made of metal or another material that would provide spring coil tension for the hinge. The handle latch could be made of any material with sufficient substance and strength to enable the user to pull the spring hinge into an open position. The handle latch also serves to hold another hinged object in place (e.g. a table leg or a cabinet door).

The optional anchor could be made of the same material as the handle or something different, as long as it provides sufficient strength for attaching the spring hinge with handle latch.

### BRIEF DESCRIPTION OF THE FIGURES

Disclosed herein is a spring hinge with handle latch with an optional anchor for attaching the device. The present disclosure also relates to various possible uses of the spring hinge with handle latch herein.

FIG. 1 depicts a front-view of one embodiment of a spring hinge with handle latch disclosed herein.

FIG. 2 depicts a perspective-view of one embodiment of a spring hinge with handle latch disclosed herein.

FIG. 3 depicts a perspective-view of one embodiment of a spring hinge with handle latch disclosed herein.

FIG. 4 depicts a side-view of one embodiment of a spring hinge with handle latch disclosed herein.

FIG. 5 depicts a perspective-view of one embodiment of a spring hinge with handle disclosed wherein which is mounted to the underside of a table and holding a hinged table leg in a stored position.

FIGS. 6 and 7 depict side-views of one embodiment of a spring hinge with handle disclosed wherein which is mounted to the underside of a table and holding a hinged table leg in a stored position.

FIG. 8 depicts a side-view of one embodiment of a spring hinge with handle disclosed wherein which is mounted to the underside of a table. Here, the spring hinge with handle latch is opened so that the hinged table leg is able to swing freely on its hinge.

FIG. 9 depicts a perspective-view of one embodiment of a spring hinge with handle disclosed wherein which is mounted to the underside of a table. Here, the spring hinge with handle latch is opened so that the hinged table leg is able to swing freely on its hinge.

FIG. 10 depicts a perspective-view of one embodiment of a spring hinge with handle disclosed wherein which is mounted to the underside of a table. Here, the spring hinge with handle is closed to enable the hinged table leg to be extended and secured by the spring hinge with handle abutting against it. This shows table leg's intended position for the table to stand upright.

FIGS. 11 and 12 depict side-views of one embodiment of a spring hinge with handle disclosed wherein which is mounted to the underside of a table. Here, the spring hinge with handle is closed to enable the hinged table leg to be extended and secured by the spring hinge with handle abutting against it. This shows table leg's intended position for the table to stand upright.

FIG. 13 depicts a perspective-view of one embodiment of a spring hinge with handle disclosed wherein which is mounted to a collapsible hand cart. In this view, the spring hinge with handle is in a closed position holding the foldable cart sections together.

FIG. 14 depicts a perspective-view of one embodiment of a spring hinge with handle disclosed wherein which is mounted to a collapsible hand cart. In this view, the spring hinge with handle is again in a closed position; however, here, it is securing a hinged handle of a collapsible cart in its extended position.

FIG. 15 depicts a perspective-view of one embodiment of a spring hinge with handle disclosed wherein which is mounted to a storage bin (such as in a recreational vehicle, airplane, bus, train, etc., however, not limited to vehicles). In this embodiment, the spring hinge with handle holds a bin door with a hydraulic hinge secure in a closed position. Without it, the door would spring open. Pulling the handle+6 of the device releases the door and allows it to open. FIG. 16 depicts said embodiment while the storage bin door is open.

FIG. 17 depicts a perspective-view of one embodiment of a spring hinge with handle disclosed wherein which is mounted to a ceiling hatch, floor hatch, escape hatch, or other hatch door. FIG. 17 depicts the spring hinge with handle is in a closed position and it is securing the door closed. FIG. 18 depicts said embodiment while the hatch door is open.

FIG. 19 depicts a perspective-view of one embodiment of a spring hinge with handle disclosed wherein which is mounted to a cabinet frame. FIG. 19 depicts the spring hinge with handle in a closed position and it is securing the cabinet door closed. FIG. 20 depicts said embodiment while the cabinet door is open.

### DRAWINGS—REFERENCE NUMERALS

10 handle
20 spring hinge
30 anchor (optional)

### DETAILED DESCRIPTION

Disclosed herein is a spring hinge with handle latch with an optional anchor for attaching the device. Without the optional anchor, the spring hinge with handle latch is attached directly from the spring hinge. This can be accomplished with screws or bolts through mounting holes on the spring hinge or any other methods such as welding, gluing, strapping, etc.

The present disclosure and drawings also relate to multiple examples of use of the spring hinge with handle latch herein.

The spring hinge with handle latch disclosed herein can be any fixture wherein securing or releasing a hinged object or a container lid could be desirable. In some embodiments, the spring hinge with handle latch is a hardware device for securing and releasing components of furniture, cabinetry, containers, doors, carts, and other items with hinged parts.

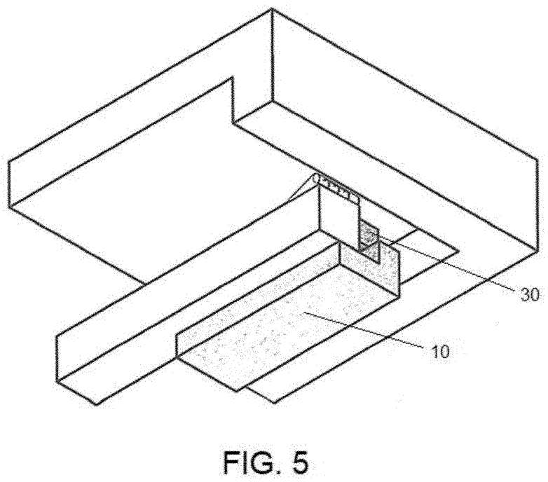

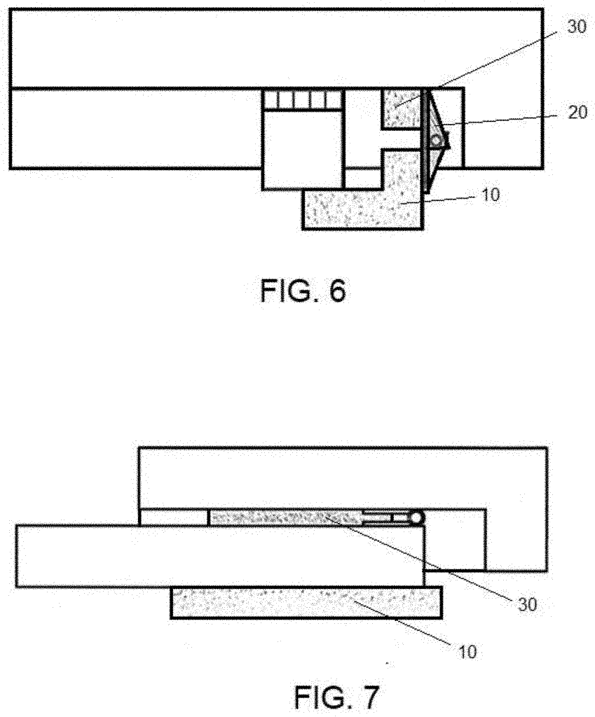

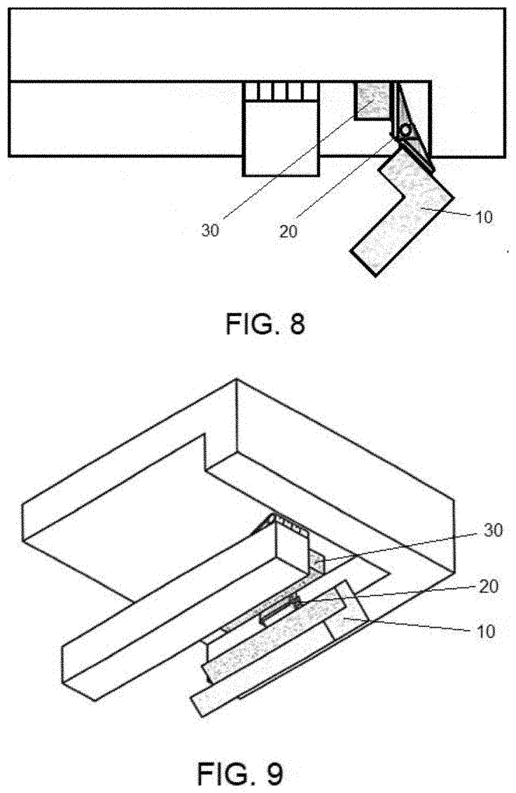

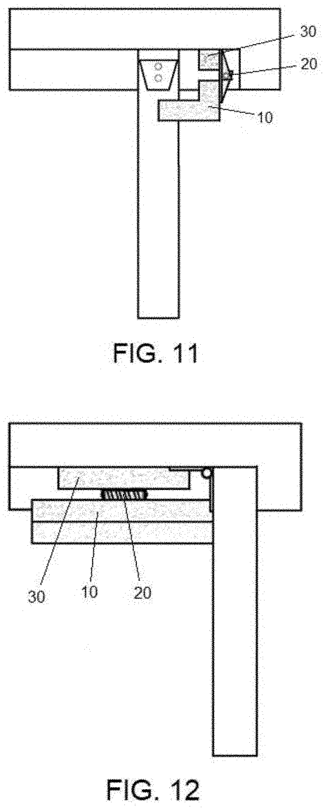

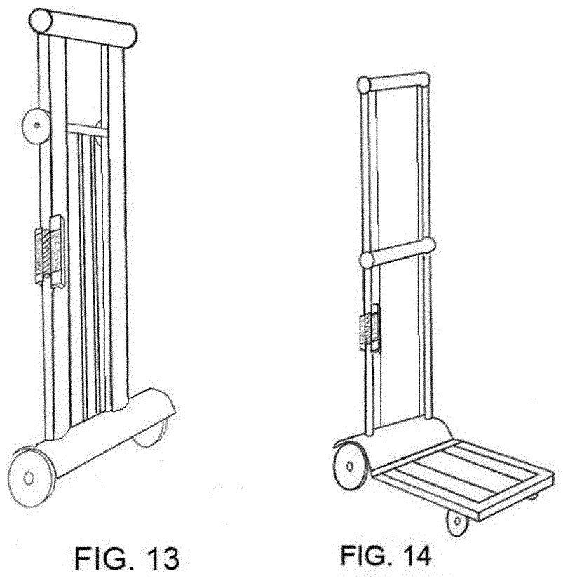

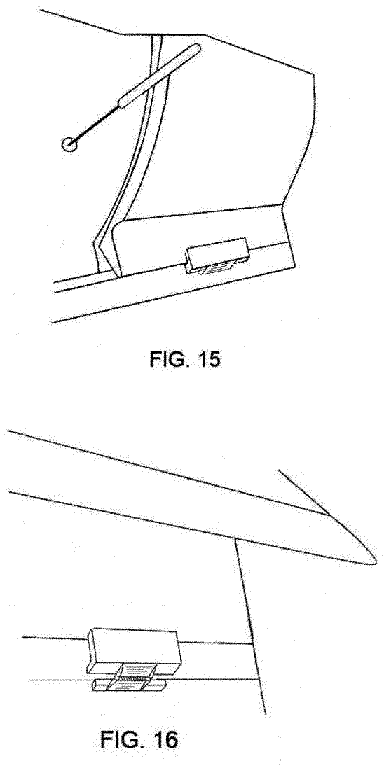

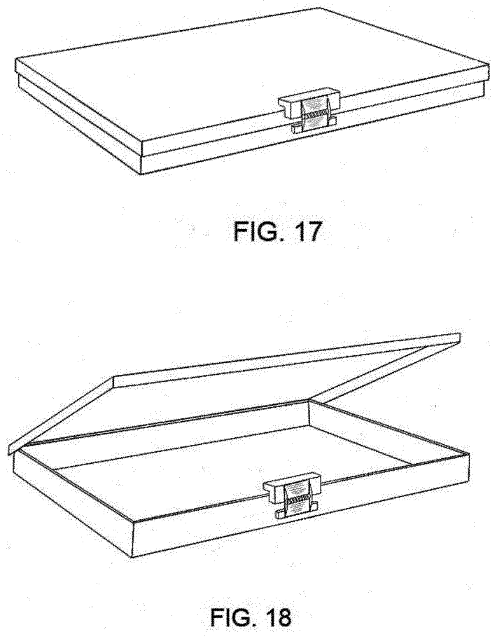

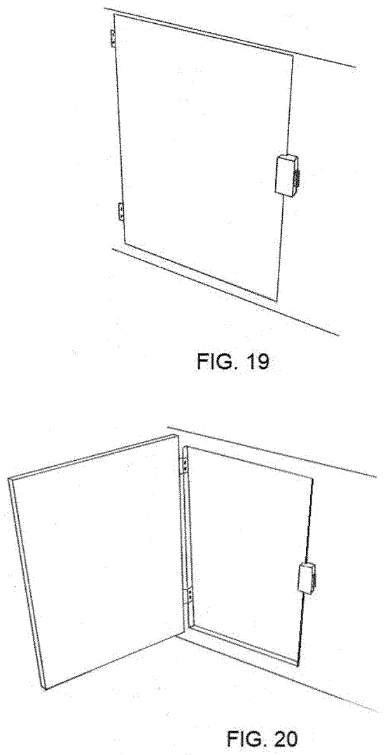

FIGS. 5-20 depict exemplary embodiments of the spring hinge with handle latch described herein.

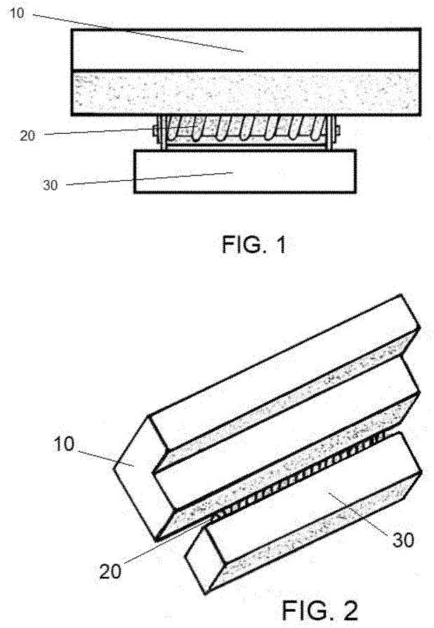

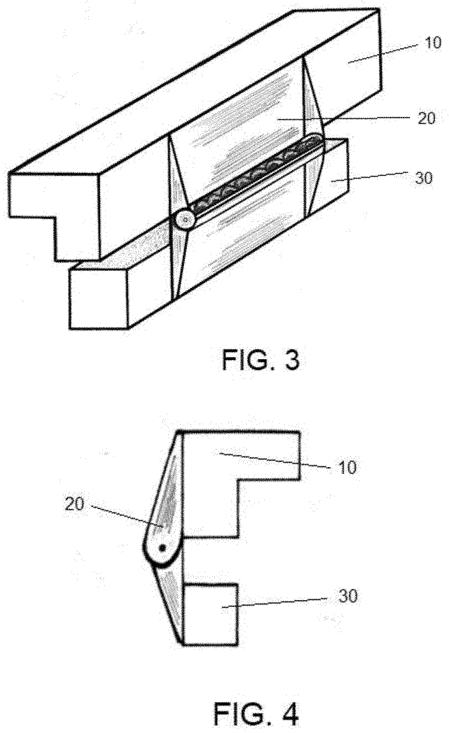

One embodiment of the spring hinge with handle latch is illustrated in FIG. 1 (front view), FIG. 2 (front perspective view), FIG. 3 (rear perspective view), and FIG. 4 (side view).

The spring hinge with handle latch consists of a spring hinge 20 with two fabricated attachments 10 and 30, one of which is optional 30.

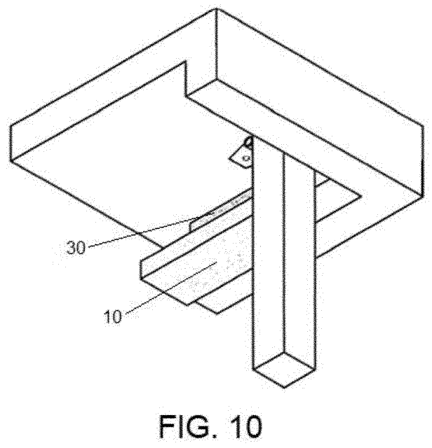

The handle latch 10 is affixed to one of the leaves of the spring hinge and serves four primary roles:
1. as a handle for leverage to open and close the device.
   Pulling on the handle releases a hinged table leg, door, or other hinged extension so that the table leg, door or other extension is free to move into its extended or other positions.
2. to secure a hinged part of an apparatus (e.g., a table leg, door, or container lid) into a stored or closed position.
   The closed/released position of the spring hinge with handle latch (i.e., device handle released by user) enables it to hold a table leg, door, or other hinged extension into its stowed or closed position, as depicted in FIGS. 5, 6, 7, 13, 15, 17, and 19.
3. to secure a loose part of an apparatus (e.g., container lid) to the main body of said apparatus.
   When in the closed position, the handle secures and/or stabilizes table legs, carts, doors, etc. on respective affixed apparatuses.
4. to secure and/or stabilize a hinged part of an apparatus (e.g., table leg) in said part's extended position, as depicted in FIGS. 10, 11, 12, and 14.
   The other attachment 30 affixed to the opposite spring hinge leaf 20 serves as an anchor component. This anchor is optional depending on the surface requirements for attaching the device.

What is claimed is:

1. A spring hinge with handle latch comprising of:
A spring hinge with a handle affixed to one leaf of the spring hinge.

2. The spring hinge with handle latch of claim 1, wherein an anchor piece for attaching the device is affixed to the opposite leaf of the spring hinge.
